(19) United States
(12) Patent Application Publication
(10) Pub. No.: US 2003/0145010 A1
(43) Pub. Date: Jul. 31, 2003

(54) Method and system for material inventory control

(76) Inventors: Hung-Liang Chiu, Taipei (TW); Chih-Heng Huang, Taipei (TW)

Correspondence Address: SAWYER LAW GROUP LLP, P O BOX 51418, PALO ALTO, CA, 94303, US

(21) Appl. No.: 10/066,190

(22) Filed: Jan. 31, 2002

(51) Int. Cl. G06F 7/00

(52) U.S. Cl. 707/100

(57) ABSTRACT

A method and a system for material inventory control are proposed. A manufacturer can realize current inventory status of a particular material by retrieving a corresponding material inventory report generated for the material through the use of a web browser and a network system such as internet or intranet, so as to implement timely procurement of insufficient materials, and maintain efficient and safe material stock for use in product manufacture. This is further advantageous of preventing over-stocking of materials from occurrence, since material procurement is proceeded at the time of need.

### FIELD OF THE INVENTION

The present invention relates to methods and systems for material inventory control, and more particularly, to a method and a system for maintaining efficient material inventory, allowing a manufacturer to immediately monitor a current status of material stock quantity through the use of a network system such as internet or intranet, so as to organize timely procurement of insufficient materials for meeting the production schedule.

### BACKGROUND OF THE INVENTION

Generally, a manufacturer uses man power to maintain and manage inventory control of both raw materials for meeting the manufacturing schedule and finished products based on the received orders and estimated projected orders with the view of providing the products to the customers in time. Typically, the conventional scheme is, the manufacturer usually command the purchase department to buy materials in advance for the smooth operation of the production plant, therefore, the warehouse is often over stocked with raw materials. However, for instance, in the event that the market price goes down, as usually anticipated in this competitive world, for example, the internal component such as CPU of a computer, as a result the manufacturing cost would surely be higher than the selling price. On the other hand, if the inventory of raw material is insufficient, then operation of production line would be adversely affected. In other words, due to insufficient supply of raw materials, the production line has to be stopped, thereby causing the waste of labor costs and delays in meeting customers' orders.

Further, since conventional inventory control dependent on the manual management requires a considerable number of personnel, therefore it is labor-consuming and time-ineffective to implement. Besides, human errors are unavoidable, and therefore, the inventory control following the conventional scheme is less efficient and less accurate in lack of reliability.

### SUMMARY OF THE INVENTION

A primary objective of the present invention is to provide a new method and a system for material inventory control, whereby an inventory management department of a manufacturer can be informed of current material inventory conditions, so as to manage and provide sufficient materials as required in the manufacturing schedule, and to maintain efficient and safe quantity of material stock.

In accordance with the above and other objectives, the present invention proposes a method and a system for material inventory control. The method for material inventory control comprises the steps of: (1) receiving production management data that include customer's order data, estimated order data and material stock data, etc; (2) calculating usage quantities of materials in the customer's order data and the estimated order data according to material codes and a production schedule, wherein each of the materials is designated by a unique material code for identification purpose; (3) deducting the calculated usage quantities obtained in the step (2) from stock amounts in the material stock data of the corresponding materials according to the material codes and the production schedule; (4) generating material inventory reports composed of the deducted results obtained from the step (3), and storing the material inventory reports into an inventory database; and (5) connecting the inventory database to a web site server, wherein the web site server is internet or intranet, allowing the manufacturer to browse and retrieve the material inventory reports stored in the inventory database by using a web browser through internet or intranet, so as to realize current status of material inventory and implement timely procurement of materials insufficient in the production schedule.

The system for material inventory control of the invention comprises: a production management database for storing production management data that include customer's order data, estimated order data and material stock data, etc; a processing module for retrieving data stored in the production management database and manipulating the retrieved data in a manner that, usage quantities of materials in the customer's order data and the estimated order data are calculated according to material codes and a production schedule, with each of the materials being designated by a unique material code for identification purpose; the calculated usage quantities are deducted from stock amounts in the material stock data of the corresponding materials according to the material codes and the production schedule; and the deducted results are used to generate material inventory reports; an inventory database for storing the material inventory reports generated by the processing module; and a web-site server module connected to a network system, allowing the manufacturer to input an inquire material code by using a web browser through the network system, and browse a material inventory report stored in the inventory database corresponding to the inputted material code.

In the use of the method and system for material inventory control of the invention through internet or intranet, a manufacture can implement timely procurement of insufficient materials, and maintain efficient and safe material stock for use in product manufacture, with a further advantage of preventing over-stocking of materials from occurrence, since material procurement is proceeded at the time of need.

### BRIEF DESCRIPTION OF THE DRAWINGS

The present invention can be more fully understood by reading the following detailed description of the preferred embodiments, with reference made to the accompanying drawings, wherein:

FIG. 1 is a schematic block diagram showing a basic structure of a system for material inventory control of the invention;

FIG. 2 is a schematic diagram showing the steps for proceeding a method for material inventory control in the use of a system for material inventory control of the invention; and

FIG. 3 is a schematic diagram showing a display page of a material inventory report generated by using a method and a system for material inventory control of the invention.

### DETAILED DESCRIPTION OF THE PREFERRED EMBODIMENTS

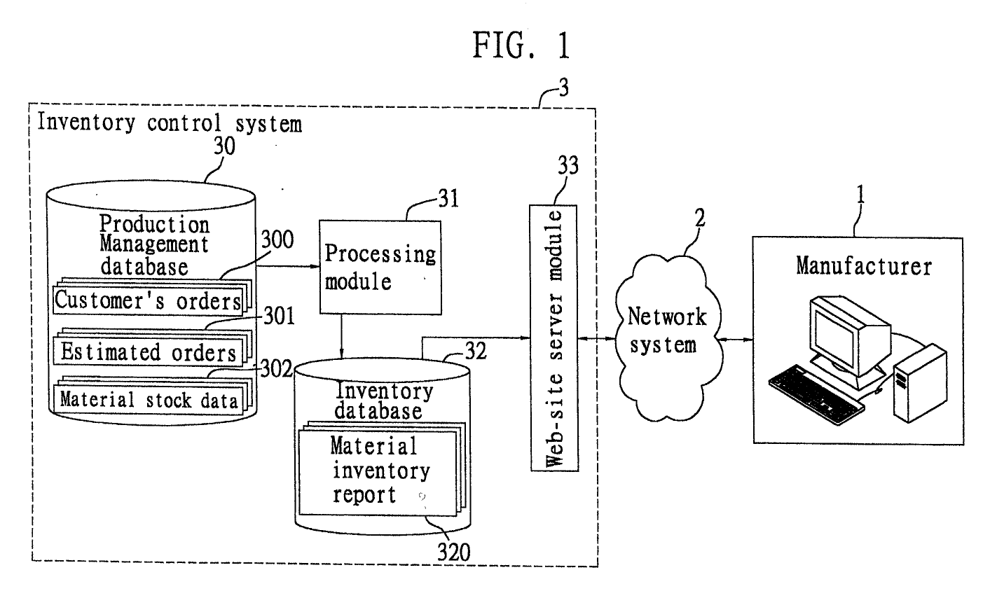

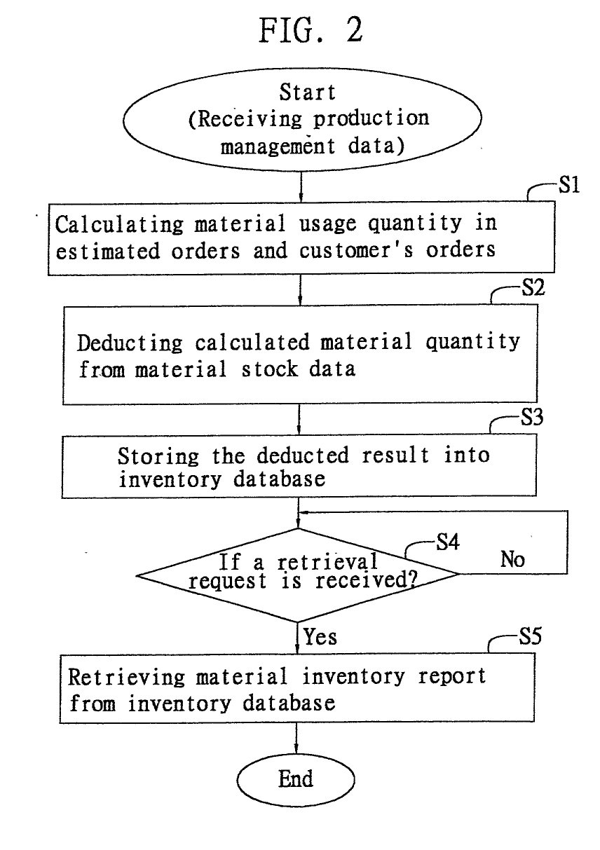

Preferred embodiments of a system and a method for material inventory control of the present invention are described in detail as follows with reference to FIGS. 1 and 2.

Referring first to FIG. 1, the system for material inventory control (designated by the reference numeral 3 and encompassed by the dotted line in the drawing) of the invention, is connected to an internal information system of a manufacturer 1 through a network system 2 such as internet or intranet, so as to allow an inventory management department of the manufacturer 1 to on-line retrieve material inventory data in real time, for maintaining efficient and safe storage level of inventory of raw materials and finished products. The system for material inventory control 3 of the invention comprises a production management database 30, a processing module 31, an inventory database 32, and a web-site server module 33.

The production management database 30 is used for storing data relating to production management, for example, but not limited to, customer's order data 300 received by a sales department of the manufacturer 1, estimated order data 301 projected by the sales department, and material stock data 302 of raw materials and finished products provided by the inventory management department, etc. The data stored in the production management database 30 can be transmitted from, for example, a back-end device such as a desktop computer, to the sales or inventory management department, which then processes the transmitted data to build up production management information as reference required in product manufacture. In addition, the production management related information can also be built up in other ways; for instance, the manufacturer 1 is connected to the system for material inventory control 3 of the invention through the network system 2 (such as internet), and then transmits electronic orders (including customer's orders and estimated orders) in EDI (electronic data interchange) format to the production management database 30 for storage. Since the EDI format is well known for use in transmission of electronic data in the art, it will not be further described hereinafter. And, since the processes for establishing and storing the production management information are not directly related to the technology and scope of the invention, no further description thereof will be detailed herein.

The processing module 31 is used for retrieving data stored in the production management database 30 and calculating the retrieved data to establish a material inventory report 320. This is accomplished by that, the processing module 31 first determines usage quantities of materials designated by same material codes in both customer's order data 300 and estimated order data 301, so as to calculate daily or weekly required amounts of the materials used for product manufacture. Then, the processing module 31 retrieves stock quantities of the materials from material stock data 302, and deducts the daily or weekly required amounts from the retrieved stock quantities according to the production schedule, so as to generate a material inventory report 320 for each of the materials.

The inventory database 32 is used for storing the material inventory reports 320 established by the processing module 31. Further, the processing module 31 can update the material inventory reports 320 in response to deletion, addition or renewal of data stored in the production management database 30, and transmits the updated material inventory reports 320 to the inventory database 32 for storage.

The web-site server module 33 is linked with the network system 2 and the inventory database 32, allowing the manufacturer 1 to use the network system 2 and a web browser, such as Microsoft Internet Explorer or Netscape Navigator, for browsing the material inventory reports 320 stored in the inventory database 32.

FIG. 2 illustrates the steps for proceeding a method for material inventory control in the use of a system for material inventory control of the invention. The detailed following description is made with reference to FIGS. 1 and 2.

First, when production management data including customer's order data 300 received by a sales department of a manufacturer 1, estimated order data 301 projected by the sales department and material stock data 302 provided from an inventory management department, are transmitted from the manufacturer 1 to be stored in a production management database 30, step S1 is proceeded. In step S1, a processing module 31 retrieves the customer's order data 300 and the estimated order data 301 from the production management database 30, and calculates usage quantities of materials required for product manufacturer based on material codes and the production schedule. Then, step S2 is proceeded.

In step S2, the processing module 31 retrieves the material stock data 302 from the production management database 30, and calculates the retrieved data in a manner as to deduct the material used quantities obtained in the step S1 from material stock amounts in the material stock data 302 according to material codes, so as to establish a material inventory report 320 designated for each of the material codes. In particular, the material inventory reports 320 are generated by calculating the material stock amounts left after daily or weekly usage in product manufacture according to daily or weekly production schedule. Then, step S3 is proceeded.

In step S3, the processing module 31 stores the generated material inventory reports 320 into an inventory database 32. Then, step S4 is proceeded.

In step S4, a web-site server module 33 determines if the manufacturer 1 makes a request for retrieving material stock data. If the data retrieval request is submitted, then step S5 is proceeded; or else, the step S4 is returned.

In step S5, the web-site server module 33 retrieves a material inventory report 320 from the inventory database 32 with a material code corresponding to that contained in the data retrieval request from the manufacturer 1. The retrieved material inventory report 320 is further transmitted by the web-site server module 33 through a network system 2 to a web browser for display, allowing a purchase or inventory management department of the manufacturer 1 to realize the latest status of material stock at anytime, so that the purchase department can implement timely material procurement for maintaining a safe and efficient level of material inventory without being over-stocked.

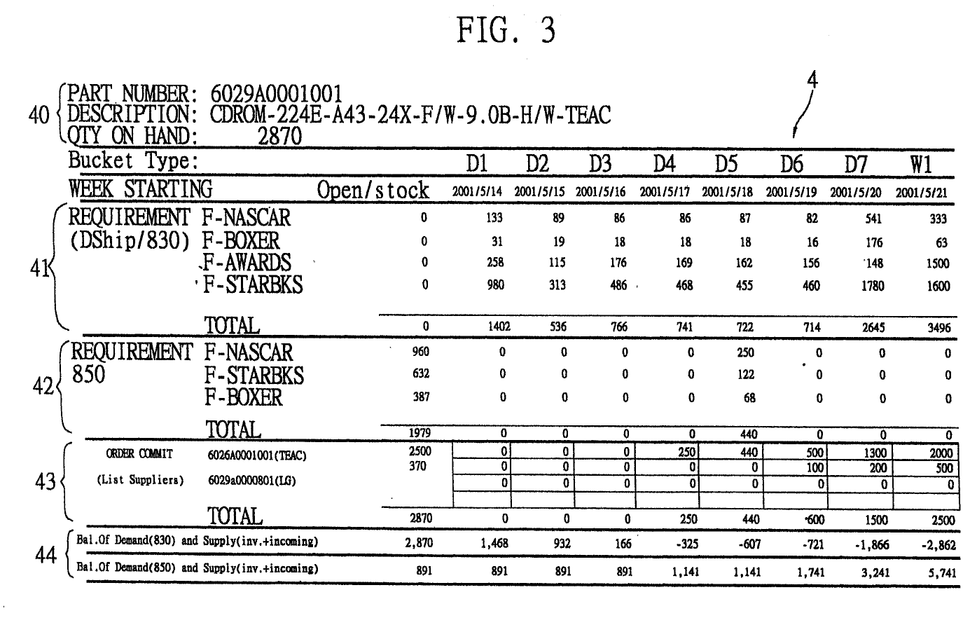

FIG. 3 illustrates a display page 4 of a material inventory report 320 generated by using a method and a system for material inventory control of the invention. The display page 4 mainly comprises a basic material data column 40, a column 41 of material usage quantities in estimated orders, a column 42 of material usage quantities in customer's orders, a column 43 of available material stock amounts, and a column 44 of calculated inventory results. A material code, e.g. “6029A0001001” in this embodiment, is considered as an identification number for a material inventory report 320. In other words, after a manufacturer 1 inputs a material code for inquiry, a web-site server module 33 retrieves a material inventory report 320 from an inventory database 32 corresponding to the inputted material code, and displays the retrieved material inventory report 320 in a web browser. As shown in FIG. 3, the basic material data column 40 indicates that current stock amount of the inquired material is “2870”; from the column 41 of material usage quantities in estimated orders and the column 42 of material usage quantities in customer's orders, usage quantities of the material on a daily basis (D1, D2, . . . D7) and weekly basis (W1, W2 . . . ) are displayed.

Besides the current material stock of “2870”, the column 43 of available material stock amounts also contains material purchased quantities received in other times; further, an to available stock amount of a material with a material code “6029A000801” is also displayed in the column 43, which material of the material code “6029A000801” can be replaceably used in place of the material with the material code “6029A0001001”. The column 44 of calculated inventory results indicates material quantity data obtained by deducting the material usage quantities in the estimated orders or the customer's orders from the available material stock amounts according to the production schedule. For example, in manipulation of deducting the material usage quantities in the estimated orders from the available stock amounts, remaining material inventory of Day D1 is “2,870−1,402=1,468”, remaining material inventory of Day D2 is “1,468−536=932”, remaining material inventory of Day D3 is “932−766=166”, remaining material inventory of Day D4 is “166−741+250=−325” etc. When the remaining material inventory of Day D4 is a minus value, it means that material shortage would happen on Day D4 (i.e. May 17, 2001), and therefore, a purchase department of the manufacturer 1 can implement material procurement before May 17, 2001 in advance for use in product manufacture, so that the occurrence of production interruption can be reduced.

Therefore, with the provision of the material inventory report 320 in the display page 4, an inventory management department of the manufacturer 1 can easily realize the latest status of material inventory, and allow the purchase department to implement timely procurement of insufficient materials and maintain efficient and safe material stock for use in product manufacture. This is further advantageous of preventing over-stocking of materials from occurrence, since material procurement is proceeded at the time of need.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for material inventory control, allowing a manufacturer to maintain safe and efficient material stock; the method comprising the steps of:
(a) receiving production management data;
(b) calculating usage quantities of materials in customer's order data and estimated order data from the production management data according to material codes and a production schedule, wherein each of the materials is designated by a unique material code for identification purpose;
(c) deducting the calculated usage quantities from stock amounts of the corresponding materials according to the material codes and the production schedule, wherein the material stock amounts are retrieved from material stock data of the production management data;
(d) generating material inventory reports composed of the deducted results and storing the material inventory reports into an inventory database; and
(e) linking the inventory database to a web-site server module, wherein the web-site server module is connected to a network system, allowing the manufacturer to browse and retrieve the material inventory reports stored in the inventory database by using a web browser through the network system, so as to realize current status of material inventory and implement timely procurement of materials insufficient in the production schedule.

2. The method of claim 1, wherein the production management data include customer's order data received by a sales department of the manufacture, estimated order data projected by the sales department, and material stock data provided by an inventory management department of the manufacturer.

3. The method of claim 1, wherein in the linking step (e), the network system is internet or intranet.

4. The method of claim 1, wherein in the linking step (e), the web-site server module is a web site server.

5. The method of claim 1, wherein in the linking step (e), the web browser is Microsoft Internet Explorer.

6. The method of claim 1, wherein in the linking step (e), the web browser is Netscape Navigator.

7. A method for material inventory control, allowing a manufacturer to maintain safe and efficient material stock; the method comprising the steps of:
(a) receiving customer's order data received by a sales department of the manufacture, estimated order data projected by the sales department, and material stock data provided by an inventory management department of the manufacturer;
(b) calculating usage quantities of materials in the customer's order data and the estimated order data according to material codes and a production schedule, wherein each of the materials is designated by a unique material code for identification purpose;
(c) deducting the calculated usage quantities from stock amounts in the material stock data of the corresponding materials according to the material codes and the production schedule;
(d) generating material inventory reports composed of the deducted results and storing the material inventory reports into an inventory database; and
(e) connecting the inventory database to a web site server, wherein the web site server is internet or intranet, allowing the manufacturer to browse and retrieve the material inventory reports stored in the inventory database by using a web browser through internet or intranet, so as to realize current status of material inventory and implement timely procurement of materials insufficient in the production schedule.

8. The method of claim 1, wherein in the step (c), the material stock data include current stock data of a material and a substituent material that is replaceably used in place of the former material.

9. The method of claim 7, wherein in the step (c), the material stock data include current stock data of a material and a substituent material that is replaceably used in place of the former material.

10. The method of claim 1, wherein in the step (d), each of the material inventory report is generated corresponding to a material code.

11. The method of claim 7, wherein in the step (d), each of the material inventory report is generated corresponding to a material code.

12. The method of claim 7, wherein in the step (e), the web browser is Microsoft Internet Explorer.

13. The method of claim 7, wherein in the step (e), the web browser is Netscape Navigator.

14. A system for material inventory control, allowing a manufacturer to maintain safe and efficient material stock; the system comprising:
a production management database for storing customer's order data received by a sales department of the manufacture, estimated order data projected by the sales department, and material stock data provided by an inventory management department of the manufacturer;
a processing module for retrieving data stored in the production management database and manipulating the retrieved data in a manner that, usage quantities of materials in the customer's order data and the estimated order data are calculated according to material codes and a production schedule, with each of the materials being designated by a unique material code for identification purpose; the calculated usage quantities are deducted from stock amounts in the material stock data of the corresponding materials according to the material codes and the production schedule; and the deducted results are used to generate material inventory reports;
an inventory database for storing the material inventory reports generated by the processing module; and
a web-site server module connected to a network system, allowing the manufacturer to input an inquire material code by using a web browser through the network system, and browse a material inventory report stored in the inventory database corresponding to the inputted material code.

15. The system of claim 14, wherein the network system is internet or intranet.

16. The system of claim 14, wherein the web-site server module is a web site server.

17. The system of claim 14, wherein the web browser is Microsoft Internet Explorer.

18. The system of claim 14, wherein the web browser is Netscape Navigator.
